(19) United States
(12) Patent Application Publication
(10) Pub. No.: US 2008/0307265 A1
(43) Pub. Date: Dec. 11, 2008

(54) Method for Managing a Software Process, Method and System for Redistribution or for Continuity of Operation in a Multi-Computer Architecture

(76) Inventor: Marc Vertes, Saint-Lys (FR)

Correspondence Address: IBM CORPORATION;INTELLECTUAL PROPERTY LAW, 11501 BURNET ROAD, AUSTIN, TX, 78758, US

(21) Appl. No.: 11/813,908

(22) PCT Filed: Jun. 22, 2005
(86) PCT No.: PCT/FR2005/001564

§ 371 Date: Jul. 16, 2007

(30) Foreign Application Priority Data
Jun. 30, 2004 (FR) 04 07180

(51) Int. Cl. G06F 11/14

(52) U.S. Cl. 714/38; 714/E11.115

(57) ABSTRACT

This invention relates to a method for managing a software application functioning in a multi-computer architecture (cluster). This management is applied, for example, to the analysis or modification of its execution environment, in as transparent a manner as possible vis-à-vis this application. This management is applied to operations of analysis, capture and restoration of the state of one or more processes of the application.

These operations use a controller external to the application which carries out an injection of system call instructions inside the working memory of the process(es) to be managed.

### BACKGROUND OF THE INVENTION

1. Field of the Invention

The field of the invention is that of networks or clusters of computers formed from a number of computers working together. These clusters are used to execute software applications bringing one or more services to users. Such an application can be single or multi-process, and be executed on a single computer or distributed over a number of computers, for example as a distributed application of the MPI (“Message Passing Interface”).

2. Description of the Related Art

At a given instant, in a redundant and communicating architecture context, an application is executed on a computer or on a group of computers of the cluster, called primary or operational node, whereas the other computers from the cluster are called secondary or “stand-by” nodes. Now, the use of such clusters shows that there are reliability problems, which can be due to failures of equipment or of operating systems, to human errors, or to the failure of the applications themselves.

In order to resolve these reliability problems, there are currently mechanisms, termed high availability, which are implemented on the majority of current clusters and which are based on an automatic cold reboot of the application on a backup node among one of the secondary nodes of the cluster.

However, in order to return to a situation approximating to that existing at the time of the failure, these mechanisms, based on a cold reboot, often have a significant duration and a significant complexity of implementation, which has an adverse effect on the satisfactory continuity of the service provided by the application during execution at the time of the failure.

In order to improve this continuity, it is also known, for example from the patent FR 02/09855, to provide one or more clones of the operational node, updated periodically or in real time over the secondary nodes.

Moreover, during the use of such clusters, certain hardware resources, such as computers or communication channels or lines can have a very high workload, thus creating bottlenecks, although others are under-used.

In order to improve the performance of the application, it is possible to reorganize the distribution of the application within the cluster.

However, all these techniques require intervention in the processes during execution, by functioning management operations such as operations for the analysis, capture or restoration of the processes or resources used by the application.

Now, such functionalities are not necessarily provided in the application, and the data to be traced or edited is not always accessible to functions external to the application, for example by the operating system.

If such functionalities are not provided directly inside the application, it is then costly and complex, or even impossible, to integrate these later, and this often requires the intervention of the designer of the application.

In order to implement such functionalities without intervening directly in the programming of the application, it is possible to edit certain instructions used by the application in order to enrich it with the necessary functionalities, or to add these functionalities at various stages of the compiling or execution of the application code.

For this, it is possible to edit or enrich certain modules of the operating system, for example at kernel level.

However, such modifications are harmful to the homogeneity of the different configurations used within the network, and cannot be edited easily during execution.

Supplementary libraries can also be integrated during compilation, in order to add these functionalities permanently to the executable code. Such libraries can even carry out an interposition between the calls stipulated in the application and the original libraries as described in the patent FR 02/00398, allowing these calls to be diverted to a new library, which can be edited during execution.

However, these methods require intervention at the application compilation stage, which is costly and complex, may require action by the designer of the application and be, despite all this, a source of errors or incompatibilities.

Within such an architecture, the implementation of certain process management functionalities is therefore delicate to produce without modification or intervention in the application or in the system, or both, which is a source of cost, complexity and risks producing errors.

### SUMMARY

This invention relates to a method for managing a software application functioning in a multi-computer (cluster) architecture, for example for the analysis or modification of its execution environment, in as transparent a manner as possible vis-à-vis this application. It also relates to a method for modifying or adjusting the functioning of such an application by using this functioning management method in order to effect a redistribution of its processes within a cluster. This method of redistribution can in particular be used to balance the workload between different machines in a network, or to make the application reliable by improving the continuity of operation. The invention also relates to a multi-computer system implementing this method of functioning redistribution.

One objective of the invention is thus to allow a more complete management of an application process, in a more transparent manner, for the functioning of this application.

This objective is achieved with a method for managing a software application comprising at least one primary software process, termed target process, being executed on at least one computer and in an execution environment comprising at least one execution memory space.

According to the invention, this method comprises an operation to inject at least one executable instruction into the memory space of the target process, by at least one second software process, termed controller process, external to the application and capable of acting on the running of the target process, this executable instruction producing an analysis or a modification of the execution environment of this target process.

More particularly, the injection operation comprises the steps of:
interruption of the execution of the target process by the controller process;
writing by the controller process into one part, termed reattributed area, of the memory space for execution of the target process, of injected instructions producing the analysis or modification mechanism;
execution, by the target process, of these injected instructions;
restoration by the controller process, by writing into the reattributed area, of the target process instructions which were stored there before the interruption;
subsequent execution of the target process instructions.

Advantageously, this functioning management method also comprises a combination of the following characteristics:

The target process interruption stage may be followed by at least one step of reading and backing up the instructions stored in the reattributed area and/or the state of the context for the execution of the target process at the time of its interruption.

The step of writing the injected instructions may be preceded by a step of writing, into the reattributed area, data producing a addressing correspondence between this reattributed area and another given memory space, termed mapping area.

The step of executing the injected instructions can be preceded by a step of writing, into the reattributed area, data constituting arguments of the injected instructions.

The step of executing the injected instructions may also be preceded by a step of editing of the execution context according to parameters corresponding to the injected instructions.

The step of executing the injected instructions may be followed by a step of reading of data stored in the reattributed area and/or reading of the state of the context of execution of the target process.

The step of writing the injected instructions may comprise the writing of at least one instruction for execution interrupting, in the reattributed area, after the injected instructions.

Another aim of the invention is to facilitate the implementation in the functioning of an application, in a manner as transparent as possible for this application, of functionalities enabling the analysis, capture or modification of the environment of this application or of the resources which it uses.

For this, the invention proposes a method for managing the functioning of a software application such as that above, carrying out an introspection operation of at least two introspected processes, each one of these introspected processes using a first resource, itself including a pointer designating a second resource, itself including an attribute which is accessible to said process through said pointer, the method comprising the following steps:
injection by the controller process into each of the two introspected processes of at least one system instruction producing an initial reading of the value of the attribute of the second resource corresponding to each of said introspected processes;
injection by the controller process into one of the two introspected processes, termed test process, of at least one system instruction producing a modification of the value of the attribute of the second resource corresponding to said test process;
injection by the controller process into the other introspected process, termed reference or control process, of at least one system instruction producing a second reading of the value of the attribute of the second resource corresponding to said control process;
comparison by the controller process of the value of the second reading with the value of the initial reading by said control process;
storage by the controller process of a datum representing the result of said comparison and injection by the controller process into the test process, of at least one system instruction producing a modification of the value of the attribute of the second resource corresponding to said test process, in order to give back to it its initial reading value.

For this, the invention also proposes a method for managing the functioning of a software application such as that above, carrying out an operation to capture the state of the target process, termed captured process, and comprising the steps of:
taking control of the captured process by a controller process;
injection by the controller process into the captured process of at least one system call instruction producing an analysis of the structure of the environment for executing the captured process;
storage or transmission of result data representing the result of this analysis and restoration of the memory space of the captured process;
subsequent execution of the captured process instructions.

When the application to be managed is of the multi-process, multi-task or “multi-thread” type, the capture operation described above may also be combined with the following characteristics.

The functioning management method may in particular carry out an operation to capture the state of at least two processes of this application, the interruption of these two processes being done either simultaneously or at points of their respective running with one being calculated according to the other.

When the captured process exchanges communication data with at least one other process by means of at least one inter-process software agent outside the application, the capture operation may also comprise the steps of:
injection, by the controller process into the captured process of at least one system call instruction carrying out the reading, in the inter-process agent, of at least one communication datum originating from another application process and not yet received by the captured process;
storage or transmission of this communication datum as a result datum.

When the environment for the execution of the captured process supports the transmission of characteristics between processes by heritage relationships, the capture operation may also include the steps of:
injection, by the controller process into the captured process of at least one system call instruction producing an analysis of the inheritance relationships of the captured process with at least one other application process;
storage or transmission of result data representing the heritage relationships of the captured process.

In the same context, the invention also proposes a method for managing the functioning of a software application such as that above, carrying out a restoration operation, by a controller process from data termed restart data, of the state of at least one software application process, termed restart process. The restoration operation thus comprises steps of:
interruption of the execution of the restart process by the controller process;
injection by the controller process into the restart process of at least one system call instruction creating or modifying the structure of at least one software object belonging to the execution environment of the restart process, as a function of the restart data;
writing, based on the restart data, of the storage space for executing the restart process;
launching of the restart process and subsequent execution of its instructions.

When the application to be managed is of the multi-process, multi-task or multi-thread type, the restoration operation also described above may also be combined with the following characteristics.

When the environment for executing the restart process supports or uses the exchange of communication data between several processes by means of at least one inter-process software agent outside the application, the restoration operation can also comprise a step of:
injection, by the controller process into the captured process of at least one system call instruction producing, based on the restart data, the writing within the inter-process agent of at least one datum representing a communication datum addressed to the restart process.

When the environment for the execution of the restart process supports the transmission of characteristics between processes by heritage relationships, the restoration operation can also include a stage of:
injection, by the controller process into the restart process of at least one system call instruction creating or modifying, based on the restart data, at least one heritage relationship of the restart process with at least one other application process.

Such an implementation of functionalities for managing an application process may in particular intervene in the functioning of this application and of the services which it produces, at a lower cost and at the same time reducing complexity and the risk of errors.

Now, in order to manage the functioning of an application, it is useful to best manage the fashion in which an application uses hardware resources within a cluster, at the same time limiting interventions inside the functioning of an application and the risks and complexities which this comprises.

Another aim of the invention is therefore to be able to move the execution of all or some of this application from one hardware resource to another, for example from one computer to another or from one node to another.

For this, the invention proposes to use the above method in order to carry out a method of replicating at least one process of the application, termed original process, into a clone process, comprising the following steps:
capture of the state of the original process by a method such as described above;
use of the result data, originating from the capture, in order to store a software object called checkpoint, representing a state of this original process at a point of its execution;
use of data from the checkpoint in order to restore at least one clone process into a state reproducing the state of the original process.

In the same context, the invention also proposes to use the above method in order to carry out a method of redistribution of all or part of a software application, termed redistributed, executed in a multi-computer (cluster) architecture and comprising at least one process, termed initial process, providing a processing of data while being executed at a given instant on at least one computer from the cluster, called primary or operational node, other computers from said cluster being called secondary nodes, this method of redistribution comprising the following steps:
replication of at least one initial process in at least one secondary process executed on a secondary node;
switching of all or part of the data processing from the initial process to at least one secondary process.

Such a redistribution may in particular transfer this or that calculation task from one node to the other within the cluster. It is therefore possible to redistribute the workload of the various machines, in order to obtain a better balancing of this workload within the cluster. It is also possible to move certain processes on to machines closer to the resources which use these processes or having better communications, for example in order to reduce transmission times between certain processes and the databases which they use.

According to one particular feature, the redistribution method also comprises the following steps:
replication of all the processing executed by the operational node in one or more secondary processes executed on at least one secondary node;
switching of all the data processes of said processes to at least one of the said secondary processes.

It is therefore possible to move all the processes used by a given item of equipment. This can in particular make the application independent of this item of equipment, for example in the case of a computer being down for maintenance or replacement.

With a similar objective, the invention also proposes to use the above method in order to produce a method for the suspension of a software application comprising at least one process executed on at least one computer, this suspension method comprising the following steps:
capture of the state of all the processes of the application, by a method such as described above;
use of the result data, originating from the capture, in order to store a software object called checkpoint, representing a state of this application at a point of its execution;
use of data from the checkpoint in order to restore at least one or more clone processes into a state reproducing the state of all the captured processes.

It is thus possible to back up in the storage means all of an application in its state at a given moment. Such a backup can then be saved and stored, for example as evidence or for security.

The restoration step may be carried out on the same machine or on another, at the chosen moment. It is thus possible to facilitate the maintenance or replacement of a machine, in particular if it is not possible to transfer the application into another part of a cluster. Therefore, it is also possible to facilitate the transfer of an application to one or more other machines, for example with which there are no direct digital communications.

Another aim is to propose a method for carrying out an improvement in the continuity of operation of a software application being executed in a multi-computer architecture.

This aim is achieved by a method for reliabilizing the functioning of a software application, termed reliabilized application, executed in a multi-computer architecture (cluster) and providing a given service, at least one process of this application being executed at a given moment on at least one computer from the cluster, called primary or operational node, other computers from said cluster being called secondary nodes. This reliabilization method implements a management method as described above in order to carry out at least one capture operation and at least one restoration operation, and comprises the following steps:
capture by at least one controller process of the state of all the processes of this reliabilized application;
use of the result data, originating from the capture, in order to store a software object called checkpoint, representing a state of this reliabilized application at a point of its execution;
detection within the operational node of a hardware or software failure affecting the functioning of the reliabilized application;
use of all or part of the checkpoint data in order to restore, on at least one secondary node, one or more processes of a backup application into a state reproducing the state of all the processes of the reliabilized application;
switching all or part of the service to the backup application of at least one of said secondary nodes.

More particularly, the method for managing the functioning according to the invention may associate, selectively or not selectively, capture operations to restoration operations in order to produce a holistic replication of the state of an application, termed original, into a clone application. The replication method described above is then implemented in order to replicate all the processes and resources from the original application as processes and resources in the clone application.

According to the same inventive concept, this method of continuity of functioning may of course update or restore one or more clone processes after detection of a failure rather than before, or carry out a combination of both.

Thus, the invention also proposes a method for reliabilizing the functioning of a software application, termed reliabilized, executed in a multi-computer architecture (cluster) and providing a given service, at least one process of this application, termed reliabilized process, being executed at a given moment on at least one computer from the cluster, called primary or operational node, other computers from said cluster being called secondary nodes, this reliabilization method comprising the following steps:
implementation of a holistic replication method in order to replicate, on at least one secondary node, a backup application in a state identical to that of the reliabilized application;
detection within the operational node of a hardware or software failure affecting the functioning of the reliabilized application;
switching of all or part of the service to said backup application of at least one of the secondary nodes.

The invention also proposes a multi-computer system implementing the method according to the invention.

One advantage of using a controller process different from the process to be managed, i.e. from the target process, is in particular to be able to implement the operations necessary to the functionalities of continuity or of redistribution of functioning in the form of operations external to the application, i.e. outside the memory space of the target process. These external operations are, for example, definitions of checkpoints, of triggering captures or of restoration of states, analyses or modifications of resource structures, or reading or writing of data in these resources.

These calculations and operations in fact represent a certain calculation volume of which only a small part needs to be executed from the target process. It is therefore advantageous to inject this small part, while implementing the rest of the management of the redistribution or the continuity of operation outside the application which must be redistributed or reliabilized. This enables the target process and thus all of the target application, to remain unchanged before and after a capture operation during a checkpoint (checkpointing) or a restoration point (by starting or updating a clone)

Combined with management by a controller outside the application, the fact of using a method of implementation by injection of code therefore enable access to system functionalities inside the application for tasks which demand it, without intervening in the application. Compared with the external methods of intervention used by tuning programs (or debuggers), for example “GDB”, this access from inside enables the management of a process not to depend on the limits of the functionalities specific to these debuggers. For example, this invention need not be limited, through the list of “debug symbols” from the target application, to the functions already present in this target application.

In addition, system calls produced by injection enable to use the parameters stored in the registers, and at the top of the stack, as is the case for numerous debuggers. Thus, this method by injection can also be exempt from access authorisations to certain resources such as the stack execution permission, which may exist in certain operating systems such as SELinux, SUN-Solaris or OpenBSD.

This combination of controller and injection of instructions enables to produce a method for triggering capture of a checkpoint which is simple and direct. As an indication of the order of magnitude, a basic demonstration program producing these replication functionalities for a single process with neither files nor connections can represent approximately 500 lines of programming in C language.

Moreover, the restricted and temporary aspect of the method for system call injection enables the insertion of only a few instructions in the memory space of the process to be managed and in which nothing remains at the end of the operation. This can therefore avoid “polluting” the target process, which is an advantage from the point of view both of the reliability and the maintenance of the application.

The method according to the invention has the advantage of being usable both with a target application using static executable files, i.e. including all the necessary routines, and dynamic executable files, i.e. calling on libraries of sub-programs outside the application. Furthermore, the method according to the invention enables to carry out a redistribution or a continuity of functioning, while intervening only a little or not at all outside the user's working area. In particular, the implementation of checkpoint capture (checkpointing) and restoration operations in themselves only need little or no modification of the system (kernel) or addition of system resources (kernel modules). By avoiding intervention in the system or the kernel of the nodes in question, this aspect enables, inter alia, to minimize the requirements for system specialists, and homogenize the system configurations installed on the various computers of the cluster.

Furthermore, the fact that the controller process can carry out a restoration of the state of a restart process without having itself effected the start of this restart process enables working on an existing restart process. This possibility enables the management of redistribution or continuity of operation not to interfere with the methods of starting a target application or its processes, which facilitates for example the application of the invention to distributed applications (MPI).

### BRIEF DESCRIPTION OF THE DRAWINGS

Other features and advantages of the invention will become apparent from the detailed description of one embodiment, which is in no way limitative, and the appended drawings in which:

FIG. 1a represents the organization of a cluster executing a software application, the functioning of which is reliabilized by a redistribution application implementing a method according to the invention in order to carry out a complete redistribution;

FIG. 1b represents the organization of a cluster executing a software application, the functioning of which is adjusted by a redistribution application implementing a method according to the invention in order to carry out a partial redistribution;

FIG. 2 is a symbolic diagram of the running of an operation for the injection of program instructions by a controller process within a target process;

FIG. 3 is a symbolic diagram of the functioning of an operation to capture the state of a process;

FIG. 4 is a symbolic diagram of the functioning of an operation to restore a restart process;

FIG. 5 is a diagram illustrating the structure of two processes using shared or separate file descriptors;

FIG. 6 is a diagram illustrating the running of a multi-process introspection method using an injection of system calls.

### DETAILED DESCRIPTION

In the following description, examples of commands or instructions used in order to implement the method according to the invention are presented using C language and for an environment or operating system of the Unix type or derived from it, in particular POSIX. Of course, other languages or system environments can be used in order to implement the invention.

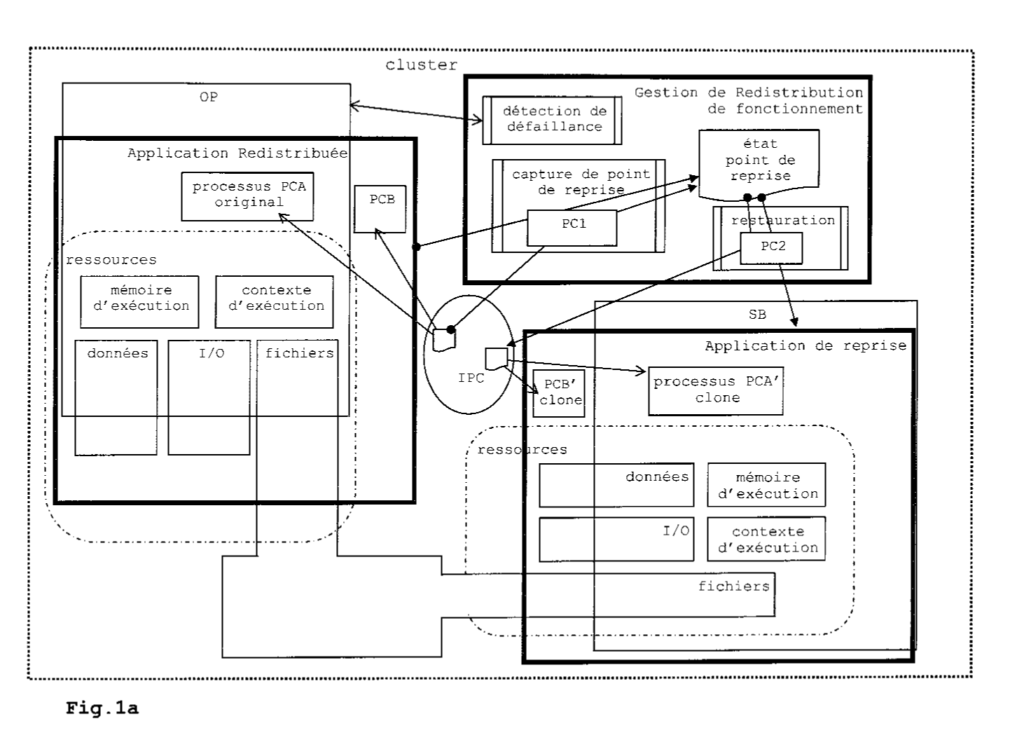

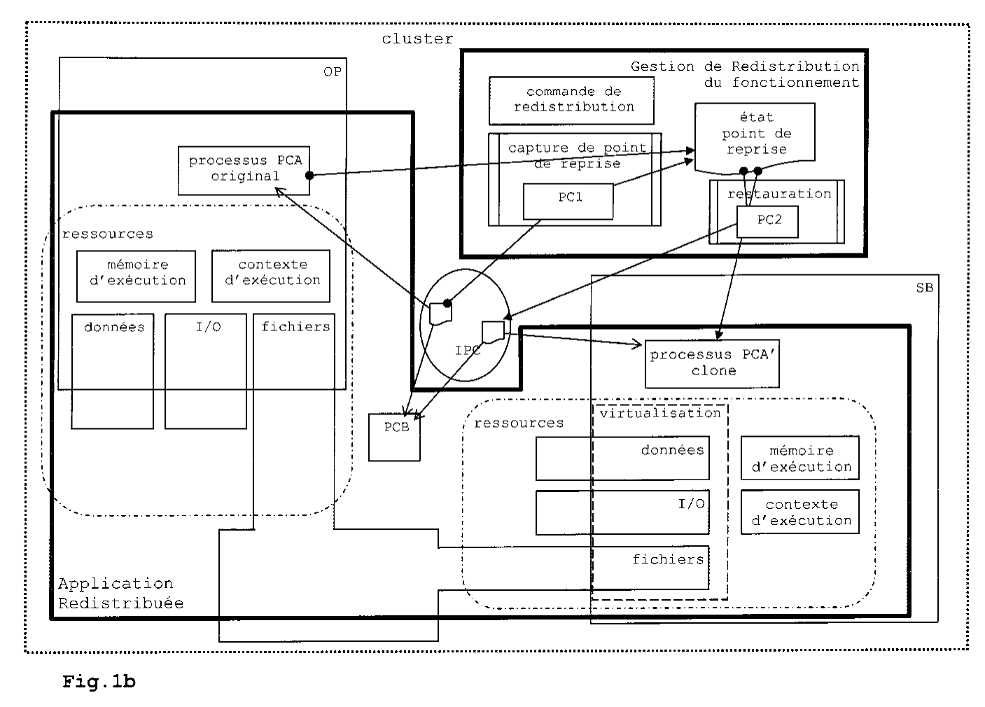

The uses of a replication method according to the invention in an application for the redistribution of functioning are illustrated in FIGS. 1a and 1b. This application for the redistribution of functioning is used in order to redistribute the functioning of a software application, termed redistributed application, executed in an operational node OP from a multi-computer architecture or cluster. Such a node can be a single computer within the cluster or comprise several computers working together within the cluster.

The redistributed application comprises at least one process termed original process PCA, working in an execution environment in which it accesses a certain number of resources of different types. These resources commonly comprise:
an execution memory space allocated in the working memory of the node OP, and where the executed instructions constituting the process are stored;
an execution context, including memory registers and various types of state resources such as flags, mutex, etc.;
I/O (Input/Output) memory zones used by the computer in order to manage inputs and outputs with the user or other software or hardware participants;
stored data, for example variables managed by the process or data files some of which can be shared with other applications, not represented, communicating with the redistributed application.

Among the resources accessible to a process some may happen to be distributed over a number of computers or several nodes, in particular in the case of distributed applications, for example for variables stored in shared memory zones or in the form of shared files or external databases.

The functioning redistribution application is executed on one or more computers from the cluster, communicating with the application's operational node and with at least one secondary node SB. This redistribution of functioning is done by storing in a regular manner or by event, in a checkpoint, an instantaneous state of one or more original processes PCA from the redistributed application.

When triggering a checkpoint, the redistribution application carries out a checkpoint capture operation, according to a method described below. According to the invention, this checkpoint capture operation uses a method of managing the functioning of the redistributed application, described below, implemented by a temporary controller process PC1 acting on the original process PCA of the redistributed application.

On completion of this checkpoint capture, the redistribution application stores a software object, termed checkpoint state, in the storage means within the cluster. In addition to the capture operation according to the invention, certain resources of the redistributed application, such as databases or files, can also be backed up or replicated in real time or by stages, according to known means.

In an embodiment, the redistribution application carries out a complete redistribution of the redistributed application, i.e. all its processes and the links which use them.

As illustrated in FIG. 1a, such a complete redistribution may in particular be used to reliabilize the redistributed application, by constituting a backup application, which will maintain a certain continuity in the service provided in the event of failure of the operational node OP.

For this, the functioning redistribution application uses a checkpoint state to carry out one or more restorations of the redistributed application in the form of at least one backup application, termed restart application. Such a restart operation comprises a clone process executed on a secondary node SB of the cluster and the resources guaranteeing to it a state corresponding to the state of the original process PCA on the capture of this checkpoint.

This restoration may be carried out in a regular manner or by event, and may comprise a complete start-up with creation of the clone process, also called restart process, or carry out a restoration by updating an already existing clone process.

During this restoration, the redistribution application carries out an operation for updating the clone process according to a checkpoint, according to a method described below. According to the invention, this update operation uses a method of managing the functioning, described below, implemented by a temporary controller process PC2 acting on the clone process of the restart application by injection of system calls, as described below.

In the event of failure affecting the functioning, over the operational node, of the reliabilized application, the application of functioning redistribution is warned by a function for monitoring or detecting failure, according to known means. The functioning redistribution application thus effects a switch of service to the backup application, and the clone process then takes over the role which the original process PCA was playing before the failure.

In other embodiments, which are not represented, the service redistribution application may also carry out an update of the restart application after the failure, or a complete start-up of this restart application followed with an update according to the method of the invention.

In other particular features which are not illustrated here, such a complete redistribution may also be used to move an application completely from one node to another, for example to release this node for a hardware intervention.

By saving the checkpoint state data for a certain time before restoring the restart application, it is also possible to carry out an archiving of the redistributed application, or a suspension of this application, for example during the time of a hardware intervention on the operational node. By storing the checkpoint data on a transportable medium, it is also possible to move this application to another computer or another cluster, without the need for a computer link.

In an embodiment illustrated in FIG. 1b, the redistribution application carries out a partial redistribution of the redistributed application, i.e. by a replication of one part only of its processes and the links which unite them, at the same time re-updating the links which unite them with other processes.

When the functioning redistribution application receives a partial redistribution command, it carries out a checkpoint state applying to the process(es) to be replicated, or identifies an already stored checkpoint applying to these same processes.

For each process, termed original process PCA, to be replicated, the functioning redistribution application creates a clone process PCA′ within the node SB to which the original process PCA will be redistributed.

Based on this checkpoint state, the functioning redistribution application carries out a restoration of the clone process PCA′ into the state of the original process PCA at the moment of establishing the checkpoint. This restoration also comprises a restoration, between the different clone processes, of the state of the links which exist between their respective original processes. If the original process PCA includes links with another process PCB which has not been replicated, a link in the same state will be created and restored between this other process PCB and the clone process PCA′.

In order to enable the redistributed application to continue to function correctly, the functioning redistribution application will also create for the clone process PCB a virtualized version of all or part of the resources used by the original process PCA, or a copy of these resources. Such a virtualization may be applied for example to the process identifiers (PID), or to the file descriptor identities.

If need be, the functioning redistribution application will then be able to delete the original process PCA without interrupting either the continuity of functioning of the redistributed application or of the services provided.

Such a partial redistribution may in particular be used to adjust the functioning of the redistributed application, by moving certain processes to other nodes in order to modify the distribution of the workload within the cluster, for example with a view to improving performances. This workload may for example be calculating, or file access, or network communications internal to the cluster or with the outside world. A partial redistribution may also be used to release a node or a line of communication within the cluster, for example in order to carry out interventions on the hardware which constitutes it.

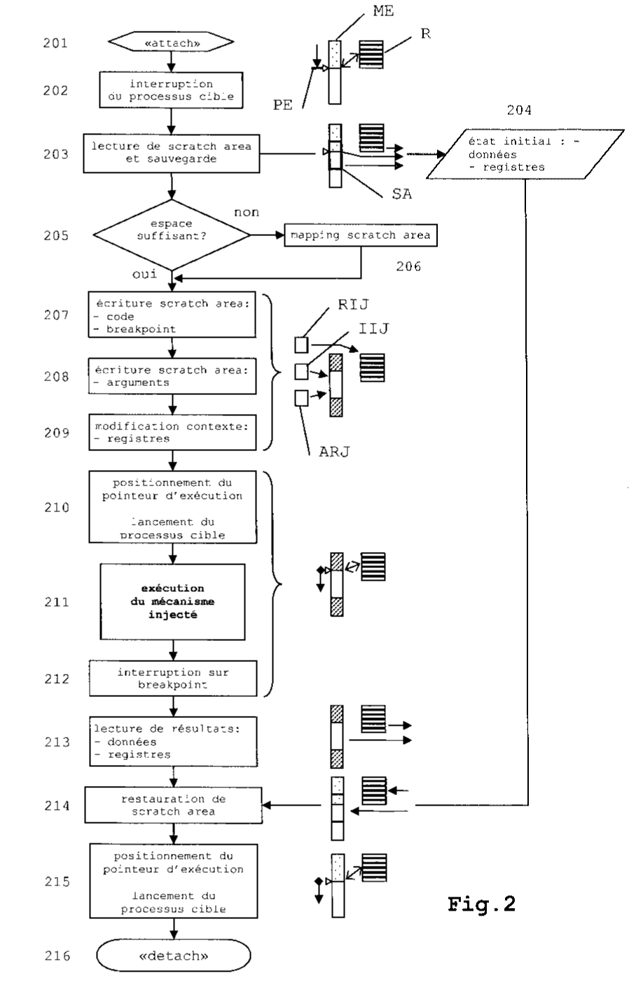

FIG. 2 illustrates more precisely the method of managing the functioning mentioned above.

This method is implemented by a controller process and applied to a process to be managed, or target process, on which it carries out a mechanism for injecting program instructions. In this figure, as regards certain steps or groups of steps, certain operations carried out by the step in question are illustrated graphically: the vertical rectangle represents the execution memory ME containing the instructions executed by the target process, the group of rectangles on its right represents the work registers R used by this process, and the triangle on its left represents the execution pointer PE of the process within the execution memory.

In the first step 201 illustrated, the controller process takes control of the target process, for example by an “attach” command based on the “ptrace” routine.

In a step 202, the controller process interrupts the execution of the target process, and defines a reattributed area SA, or “scratch area”, within the execution memory of this target process.

The controller process then carries out 203 a reading of the content of the reattributed area SA, of the position of the execution pointer PE, and of the state of the work registers R, and carries out a backup 204 of the initial state of these elements.

The controller process checks 205 that the reattributed area SA is sufficiently large to carry out the subsequent operations. If this is not the case, it can carry out 206 an addressing (mapping) of this area according to known methods, in order to make it correspond to another larger memory space, termed mapping area, given outside the execution memory ME of the target process. This mapping area may then be used by the target process instead and in place of the reattributed area.

Then 207, the controller process writes inside the reattributed area SA the code IIJ corresponding to the program instructions to be injected, and writes a breakpoint instruction at the end of the reattributed area SA.

Then 208, the controller process can write in the reattributed area SA data ARJ corresponding to optional arguments which must use the instructions IIJ.

Then 209, the controller process edits the state of the work registers R in order to give them the values RIJ corresponding to the execution of the instructions to be injected IIJ.

The controller process will then 210 set the execution pointer PE on the first instruction IIJ of the injected mechanism and launch the execution of the target process.

The target process then executes 211 the instructions IIJ of the injected mechanism, for example system calls carrying out an analysis or a modification of the structure of the resources of the target process. According to its type, the execution of the injected mechanism may receive returned data, which will be stored in the reattributed area SA or in the work registers R, for example the responses returned by the operating system to the system calls included in the injected mechanism.

When 212 the execution pointer PE arrives at the breakpoint instruction written previously 207, the target process is interrupted again and recalls the controller process.

The controller process will then 213 collect the results from the execution of the injected mechanism, in the form of the result data read in the reattributed area SA and in the work registers R, and back up this result data independently of the target process execution environment.

Then 241, the controller process uses the initial state data backed up 204 previously in order to write into the reattributed area SA and the work registers R and restore them to the state where they were on the initial interruption 202.

The execution memory space is then restored to the state in which it was before injection of the instructions IIJ. The injection operation can thus be considered as provisional or temporary, which avoids polluting the target process or the application which uses it.

The controller process can then 215 reset the execution pointer PE on the instruction which was initially the next to be executed, and restart the target process.

Once the target process is again in execution, the controller process releases it from its control, for example by a “detach” instruction or command, based on the “ptrace” routine in a similar manner to the “attach” command.

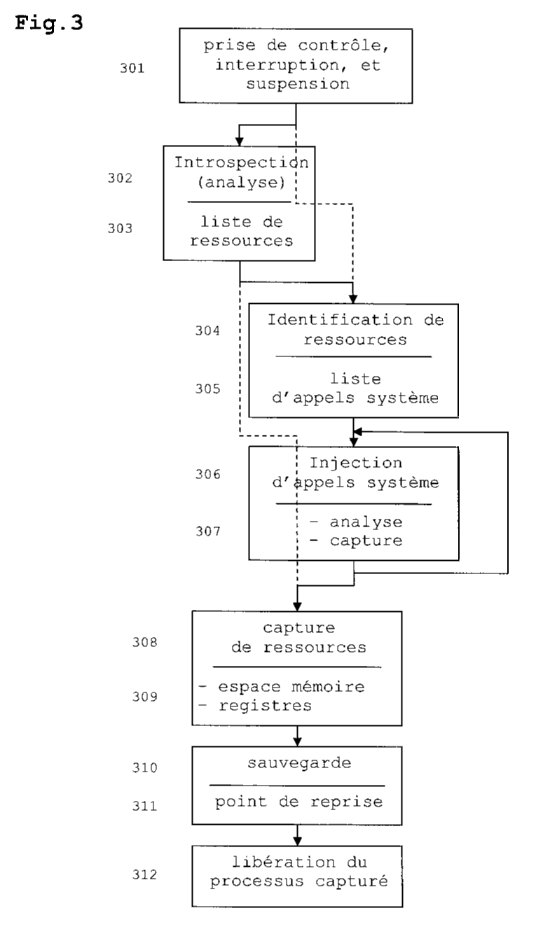

FIG. 3 illustrates the use of the method of managing the functioning according to the invention in order to carry out an operation to capture the state of a process, termed captured process, and of its execution environment, by a controller process.

In the first stage 301 represented, the controller process first takes control of the target process, for example by an “attach” command based on the “ptrace” routine. The controller process can then interrupt the execution of the captured process during this step and suspend all or part of the resources which it uses.

A next step 302 consists of carrying out an introspection of the operating environment of the captured process in order to establish a list 303 of the resources of this execution environment. The controller process analyses the structure of the resources to which it has access.

The majority of these resources are directly accessible by the controller process, for example by the pseudo-file system instruction “/proc”.

Accordingly, the instruction

“/proc/pid/fd”: provides the list of file descriptors (fd) currently open and thus to be backed up, for the process in question (pid);

“/proc/pid/maps”: provides the organisation and the addressing of the memory segments used.

Once it has identified 304 the resources which are not directly accessible to it, the controller process establishes a list of instructions to be injected into the captured process in order to access these resources, for example in the form of a list of system calls 305 and their parameters.

In a recursive step 306, the controller process injects each instruction or group of instructions from this list and collects the result data from this, according to the method of managing the functioning described above. By this injection of system calls, the controller process obtains data 307 representing the structure of the resources which were not directly accessible to it.

For the introspection of certain resources whose structure is not directly accessible by a system call within a single target process, this step 306 carries out a multi-process introspection method with injection of system instructions. This method carries out a number of mutually co-ordinated injection operations, applied to several target processes. The injection operations introduce modifications in such a resource by means of at least one of these target processes. The results from these operations are then compared with each other in order to obtain information applying to way of functioning of the introspected resource.

From the structure obtained by direct introspection 302 or by injection of system calls 306, the controller process can then capture 308 the content of these same resources and back it up 310 in order to constitute a checkpoint state 311, i.e. an image of the state of the captured process.

Accordingly, the instruction

“/proc/pid/mem” enables to read the content of the memory space in the form of a read access file;

“ptrace(PT_GETREGS, . . . )” enables to access to the work registers.

The controller process then restarts the execution of the captured process and releases it 312 from its control, for example by a “detach” command, based on the “ptrace” routine in a similar manner to the “attach” command.

If necessary, the system calls injection phase 306 may also be used in order to obtain the content or the state of certain resources, by injecting the corresponding read instructions.

Below are shown, as an example in C language for a POSIX environment, program instructions used in a controller process PC1 in order to take control 301 of a process whose identifier is “pid”, i.e. the value of which is contained in the variable named “pid”.

Instruction for loading the “ptrace” function:

#include <sys/ptrace.h>

Definition of the “attach” function which carries out this takeover:

int attach(int pid)
{

int status;
/* takeover of a process by ptrace. The process
* is defined by its process id
*/
ptrace(PTRACE_ATTACH, pid, 0, 0);
/* if the process is blocked, SIGSTOP is sent to us */
waitpid(pid, &status, 0);
if (WIFSTOPPED(status)) /* STOP is in the signal template */
return 0K;
return ERROR;

}

Below are shown, as an example in C language for a POSIX environment, program instructions carrying out an injection of instructions intended to capture the setting of the pointer for writing a descriptor of the file opened by the captured process.

Declaration of a function named “ptrace_syscall”, used in order to inject any system call “syscall” associated with arguments “argc”, in a process whose identifier is “pid”:

int ptrace_syscall(pid_t pid, pid_t *tpid, int scratch, int syscall, int argc, . . . );

Definition of a macro using the “ptrace_syscall” function to be used in order to carry out the injection of the system call “I_seek” into the process whose identifier is “p”:

#define PT_LSEEK(p, fd, off, w) \

ptrace_syscall(p, 0, 0, SYS_lseek, 3, \

| | |
|---|---|
| 0, 0, fd, | \ |
| 0, 0, off, | \ |
| 0, 0, w) | |

Definition of a function, used in the functioning redistribution application, calling the macro “PT_SEEK” in order to capture the setting of the write pointer, by injecting the system call “Iseek”, matched with the parameter “SEEK_CUR”, in the process the identifier of which is “pid”:

| | |
|---|---|
| int get_file_pos(int pid, | /* process id of the attached program */ |

int fd)/* descriptor of the file opened by pid /*

{

int file_pos = PT_LSEEK(pid, fd, 0, SEEK_CUR);
return file_pos;

}

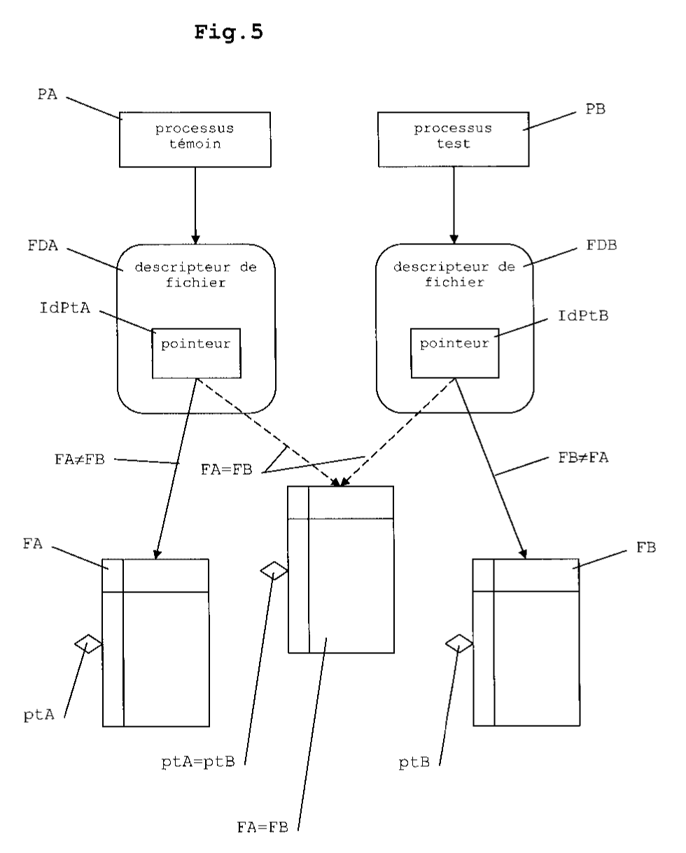

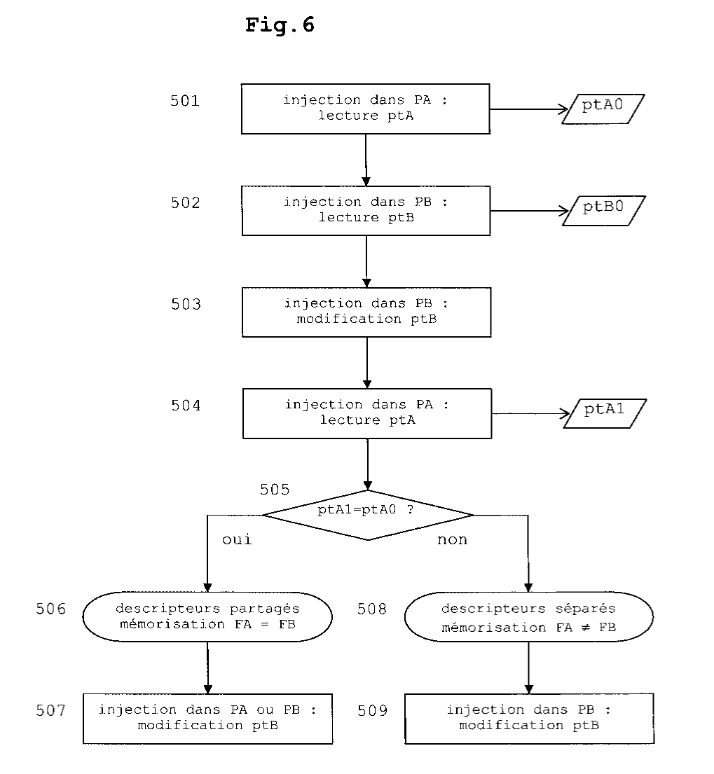

FIGS. 5 and 6 illustrate an example of a method of multi-process introspection, applied to the analysis of a file descriptor. When a child process uses a file descriptor inherited from a parent process, the two processes, parent and child, use two different descriptors, but which both point to the same file or data container provided with a single position pointer. These are therefore two different instances of a single initial object, called “shared” descriptors, as opposed to “separate” descriptors. Now, it can be useful to back up the type of such file descriptors in connection with a state capture, in order to maintain a single consistency within processes which will subsequently be restored from this capture.

The multi-process method of introspection is then used in order to determine whether two file descriptors FDA and FDB, used by two different processes PA and PB and pointing to files FA and FB, are separate or shared descriptors.

In a step 501, a controller process PC1 injects a system call into the first target process PA. This system call carries out a reading ptA0 of the setting of the read/write pointer of the file descriptor FDA of this first target process PA.

This controller process PC1 injects system call instructions into the second target process PB. In a step 502, one of these system calls first of all carries out a reading ptB0 of the setting of the read/write pointer of the file descriptor FDB of this second target process PB.

In a step 503, another of these system calls, for example an instruction “Iseek” then carries out a modification of the setting of this same pointer.

In a step 504, the controller process P1 injects a system call into the first target process PA. This system call carries out a new reading ptA1 of the setting of the read/write pointer of the file descriptor FDA of this first target process PA.

In a step 505, the controller process PC1 then compares the values ptA0 and ptA1 obtained by the two readings of the setting of the pointer of the first descriptor FD1.

If these values are equal, then this means that these two descriptors FDA, FDB use the same pointer, and are therefore shared descriptors. In a step 506, the controller process PC1 then stores a datum representing this information.

In a step 507, the controller process PC1 then injects a system call instruction into one of the two target processes, for example PB, in order to return the pointer to its initial setting ptB0.

If these values are different, then this means that these two descriptors FDA, FDB do not use the same pointer, and are therefore separate descriptors. In a step 507, the controller process PC1 then stores a datum representing this information.

In a step 508, the controller process PC1 then injects a system call instruction into the second target process PB, in order to return its pointer to its initial setting ptB0.

In both cases, the modified pointer is returned to its initial setting, and the method is accordingly completely transparent for both target processes.

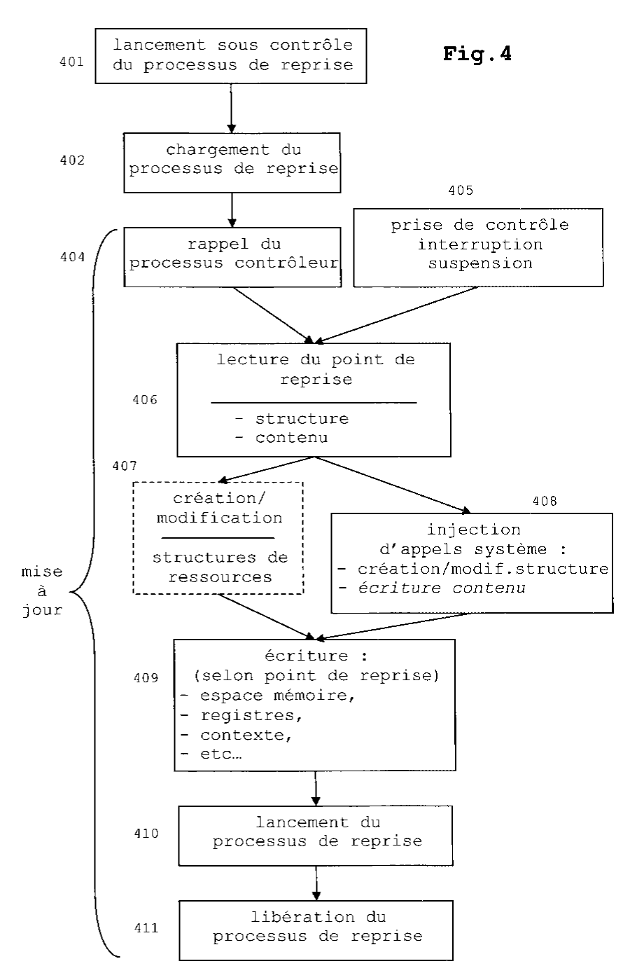

FIG. 4 illustrates the use of the method for managing the functioning according to the invention in order to carry out an operation to update or restore a process, termed restart process, and its execution environment, by a controller process.

This figure represents a restoration operation, comprising a part 401, 402, 403 of the creation of the restart process.

The controller process triggers this creation by initializing 401 a new process, termed restart process, under its control (“forking” technique), then by using an instruction “ptrace(TRACEMEM, . . . )” before launching its execution.

The restart process then normally boots by loading 402 the various resources as with a conventional cold boot.

At this step, the strictly speaking method for updating the state of a restart process begins, i.e. the method which can be used on restart process which already exists.

If the update is carried out closely following a restart process start-up, this restart process stops 404 immediately after its loading, owing to its launch method, and recalls the controller process.

If the update is carried out on a preexisting restart process, the controller process commences by taking control 405 of the captured process, for example by an “attach” instruction based on the “ptrace” routine.

The controller process then carries out 406 a selection and a reading of data backed up previously and constituting a checkpoint. From the content of this checkpoint, the controller process evaluates the modifications of structure and content to be carried out in the execution environment of the restart process as it is found in order to bring it to the selected checkpoint state.

If some of the modifications of structure are possible directly from the controller process, the latter implements this by itself 407.

For modifications of structure which are not accessible to it, the controller process prepares a list of system calls which it injects 408 into the restart process, according to the invention's method for managing the functioning.

This injection is used for example in order to modify the addressing and the mapping of the memory segments used, by injecting one or more “mmap” system calls. The same principle is used for all or part of the system resources which must be recreated in order to arrive at a state identical to the selected checkpoint state. These system resources are, for example, resources of the “file”, “socket”, “pipe”, “timer”, “terminal control” type, etc.

Once the resource structures are adequate, the controller process carries out 409 a writing of these system resources, depending on the data from the checkpoint state, in order to bring the restart process to the state where the captured process was during the establishment of the selected checkpoint.

The controller process then restarts 410 the execution of the restart process and releases it 411 from its control, for example by a “detach” command, based on the “ptrace” routine in a similar manner to the “attach” command.

If necessary, the system calls injection phase 408 may also be used in order to write the content or the state of certain resources, by injecting the corresponding read instructions.

As this is operated from a process outside the restart process, this restoration operation is quite simpler and more efficient than if it had to be done by operations provided within this restart process itself.

The program instructions carrying out an injection of instructions intended to restore the setting of the pointer for writing a descriptor of the file opened by or for the restart process are shown below, for example in C language for a POSIX environment.

These instructions use the same “ptrace_syscall” functions and the “PT_SEEK” macro as those described above for the capture operation.

Definition of a function, used in the functioning redistribution application, calling the macro “PT_SEEK” in order to restore the setting of the write pointer, by injecting the system call “Iseek”, matched with the parameter “SEEK_SET”, in the process the identifier of which is “pid”:

int get_file_pos(int pid,

| int fd) | |
|---|---|
| int filepos) | /* extract from the checkpoint */ |

{

return PT_LSEEK(pid, fd, filepos, SEEK_SET);

}

In the case of applications comprising several processes, or tasks, likely to be executed simultaneously, the establishment of a checkpoint may require the state of several of these processes to be captured. For this, the use of one or more controller processes outside the process to be captured is an advantage afforded by the method according to the invention.

In this case, the functioning redistribution application carries out a capture operation according to the invention on a number of captured processes, in order to synchronize or co-ordinate the initial interruption 301 of each of the capture operations and the suspension of the resources in question.

During a capture of several processes, certain data undergoing transmission between a number of processes can be found “fixed” within the interprocess software mechanism IPC managing these transmissions, for example the “Inter Process Communication” software object in an environment of the Unix type.

In order to avoid disturbing the consistency of the checkpoint sate which will be backed up, the functioning redistribution application uses the method for managing the functioning according to the invention in order to inject into each of the interrupted processes system calls for managing this under transmission data. This may be for example purging the queues (pipes) from the IPC of data not processed in connection with an operation to capture the process state during a checkpoint, or restoring this same data in the case of a process update.

In fact, in a situation to capture the state of several intercommunicating processes, if a process is suspended in order to be captured, there can be data queuing in the interprocess agent IPC, intended for this suspended process. Once all the processes to be captured are interrupted, for each process to be captured, the capture operation then also comprises an analysis and a storage of all the communication data, or packets, which are addressed to it but have not yet been received. In systems where this interprocess agent is managed by the system, for example in a kernel module for the Unix case, it is advantageous not to have to intervene in the system. The controller process PC1 thus uses the method of managing the functioning according to the invention in order to inject into the process undergoing capture system calls which will request a reading of this communication data in transit. The controller process then recovers this data and backs it up within the checkpoint state.

In a restoration situation, if all the restart processes are suspended, the controller process PC2 also uses the management process according to the invention in order to inject into each restart process system calls which will write into the interprocess agent IPC the packets in transit which were stored in the checkpoint state.

Furthermore, if an application comprises several processes, some of these processes can have mutual heritage relationships. In other words, a “child” process can have been created from a “parent” process, and inherit by this heritage relationship certain characteristics or resources from its operating environment, in particular of the “file descriptor” type.

During the capture of the processes of an application, the controller process PC1 will use the management process according to the invention in order to inject, into each captured process, system calls which will analyse its possible heritage relationships with one or more other processes. The results of these analyses will then be backed up in the checkpoint state undergoing constitution.

During the restoration of these same processes, the controller process PC1 will use the management process according to the invention in order to inject, into each restart process, system calls which will recreate the same heritage relationships which were stored in the checkpoint state.

Of course, the invention is not limited to the examples which have just been described and numerous modifications can be applied to these examples without exceeding the scope of the invention.

1. Method for managing a software application comprising at least one primary software process, termed target process, being executed on at least one computer and in an execution environment comprising at least one execution memory space,
characterized in that it comprises a operation to temporary inject at least one executable instruction into the execution memory space of the target process, by at least one second software process, termed controller process, external to the application and capable of acting on the running of the target process, this executable instruction producing an analysis or a modification of the execution environment of this target process.

2. Method according to claim 1, characterized in that the injection operation comprises steps of:
interruption of the execution of the target process (202) by the controller process;
writing (207) by the controller process into one part, termed reattributed area, of the memory space for execution of the target process, of injected instructions producing the analysis or modification mechanism;
execution (211), by the target process, of these injected instructions;
restoration (214) by the controller process, by writing into the reattributed area, of target process instructions which were stored there before the interruption (202);
subsequent execution (215) of the target process instructions.

3. Method according to claim 1, characterized in that it carried out an operation of introspection of at least two introspected processes, each of these introspected processes (PA, PB) using a first resource (FDA, FDB respectively) itself comprising a pointer (IdPtA, IdPtB respectively) designating a second resource (FA, FB) itself comprising an attribute (ptA, ptB) which is accessible to said process by means of said pointer, the method comprising the following steps:
injection (501, 502) by the controller process (PC1) into each of the two introspected processes (PA, PB) of at least one system instruction producing an initial reading of the value (ptA0, ptB0 respectively) of the attribute (ptA, ptB) of the second resource (FA, FB) corresponding to each of said introspected processes;
injection (503) by the controller process (PC1) into one of the two introspected processes, termed test process (PB), of at least one system instruction producing a modification of the value (ptB0) of the attribute (ptB) of the second resource (FB) corresponding to said test process (PB);
injection (504) by the controller process (PC1) into the other introspected process, termed control process (PA), of at least one system instruction producing a second reading of the value (ptA1) of the attribute (ptA) of the second resource (FA) corresponding to said control process (PA);
comparison (505) by the controller process (PC 1) of the value of the second reading (ptA1) with the value of the initial reading (ptA0) by said control process (PA);
storage (506, 508) by the controller process (PC1) of a datum representing the result of said comparison and injection (507, 509) by the controller process (PC1) into the test process (PB), of at least one system instruction producing a modification of the value (ptB0) of the attribute (ptB) of the second resource (PB) corresponding to said test process (PB), in order to give back to it its initial reading value (ptB0).

4. Method according to claim 1, characterized in that it carries out an operation to capture the state of the target process, termed captured process (PCA), comprising steps of:
taking control (310) of the captured process by a controller process;
injection (306) by the controller process (PC1) into the captured process of at least one system call instruction producing an analysis (307) of the structure of the environment for executing the captured process;
storage (310) or transmission of result data (311) representing the result of this analysis and restoration of the memory space of the captured process;
subsequent execution (312) of the captured process instructions.

5. Method according to claim 4, characterized in that it carries out an operation to capture the state of at least two processes (PCA, PCB) of this application, the interruption of these two processes being done either simultaneously or at points of their respective running in which one is calculated as a function of the other.

6. Method according to claim 4, characterized in that the captured process (PCA) exchanges communication data with at least one other process (PCB) by means of at least one interprocess software agent (IPC) outside the application, the capture operation also comprising steps of:
injection, by the controller process into the captured process of at least one system call instruction carrying out the reading in the inter-process agent of at least one communication datum originating from another application process and not yet received by the captured process;
storage or transmission of this communication datum as a result datum.

7. Method according to claim 4, characterized in that the execution environment of the captured process (PCA) supports the transmission of characteristics between processes by heritage relationships, the capture operation also comprising steps of:
injection, by the controller process into the captured process of at least one system call instruction producing an analysis of the inheritance relationships of the captured process with at least one other application process;
storage or transmission of result data representing the heritage relationships of the captured process.

8. Method according to claim 1, characterized in that it carries out a restoration operation, by a controller process (PC2) from data termed restart, of the state of at least one software application process, termed restart process (PCA′), the restoration operation comprising steps of:
interruption (404, 405) of the execution of the restart process by the controller process (PC2);
injection (408) by the controller process into the restart process of at least one system call instruction creating or modifying the structure of at least one software object belonging to the environment for executing the restart process, according to the restart data;
writing (409), from the restart data, of the storage space for executing the restart process;
launching (410) of the restart process and subsequent execution (411) of its instructions.

9. Method according to claim 8, characterized in that the environment for executing the restart process supports the exchange of communication data between several processes (PCA′, PCB′) using at least one inter-process software agent (IPC) outside the application, the restoration operation also comprising a step of:
injection, by the controller process into the captured process of at least one system call instruction producing, from the restart data, the writing within the inter-process agent (IPC) of at least one datum representing a communication datum addressed to the restart process.

10. Method according to claim 8, characterized in that the execution environment of the restart process (PCA′) supports the transmission of characteristics between processes by heritage relationships, the restoration operation also comprising a step of:
injection, by the controller process into the restart process of at least one system call instruction creating or modifying, from the restart data, at least one heritage relationship of the restart process with at least one other application process.

11. Method according to claim 1, characterised in that it carries out a replication of at least one application process, termed original process, in a clone process, and comprises the following steps:
capture of the state of the original process by a method according to one of claims 2 to 6;
use of the result data, originating from the capture, in order to store a software object called checkpoint, representing a state of this original process at a point of its execution;
use of data from the checkpoint in order to restore at least one clone process into a state reproducing the state of the original process.

12. Method according to claim 11, characterized in that it carried out a redistribution of all or part of a software application termed redistributed, executed in a multi-computer (cluster) architecture and comprising at least one process, termed initial process, providing a processing of data while being executed at a given instant on at least one computer from the cluster, called primary or operational node (OP), other computers from said cluster being called secondary nodes, this redistribution operation comprising the following stages:
replication of at least one initial process in at least one secondary process executed on a secondary node;
switching of all or part of the data processing from the initial process to at least one secondary process.

13. Method according to claim 12, characterized in that it also comprises the following steps:
replication of all the processes executed by the operational node in one or more secondary processes executed on at least one secondary node;
switching of all the data processings of said processes to at least one of the said secondary processes.

14. Method according to claim 1, characterized in that it carries out a suspension of a software application comprising at least one process executed on at least one computer, this suspension operation comprising the following steps:
capture of the state of all the processes of the application;
use of the result data, originating from the capture, in order to store a software object called checkpoint, representing a state of this application at a point of its execution;
use of data from the checkpoint in order to restore at least one or more clone processes into a state reproducing the state of all the captured processes.

15. Method according to claim 1, characterized in that it reliabilizes the functioning of a software application, termed reliabilized application, executed in a multi-computer architecture (cluster) and providing a given service, at least one process (PCA) of this application being executed at a given moment on at least one computer from the cluster, called primary or operational node (OP), other computers from said cluster being called secondary nodes (SB), this reliabilization operation comprising the following steps:
capture by at least one controller process (PC1) of the state of all the processes of this reliabilized application;
use of the result data, originating from the capture, in order to store a software object called checkpoint, representing a state of this reliabilized application at a point of its execution;
detection within the operational node of a hardware or software failure affecting the functioning of the reliabilized application;
use of all or part of the checkpoint data in order to restore, on at least one secondary node, one or more processes from a backup application into a state reproducing the state of all the processes of the reliabilized application;
switching of all or part of the service to the backup application from at least one of said secondary nodes.

16. Method according to claim 11, characterized in that it carried out a holistic replication of the state of an application termed original in a clone application, while using said replication method in order to replicate all the processes and resources of the original application as processes and resources of the clone application.

17. Method according to claim 16, characterized in that it reliabilizes the functioning of a software application termed reliabilized, executed in a multi-computer architecture (cluster) and providing a given service, at least one process (PCA) of this application being executed at a given moment on at least one computer from the cluster, called primary or operational node (OP), other computers from said cluster being called secondary nodes (SB), this reliabilization operation comprising the following steps:
implementation of a holistic replication method in order to replicate, on at least one secondary node (SB), a backup application in a state identical to that of the reliabilized application;
detection within the operational node of a hardware or software failure affecting the functioning of the reliabilized application;
switching of all or part of the service to said backup application from at least one of the secondary nodes.

18. Multi-computer system comprising a management of application processes implementing the method according to claim 1.
